(19) United States
(12) Patent Application Publication
(10) Pub. No.: US 2016/0034658 A1
(43) Pub. Date: Feb. 4, 2016

(54) SAFETY MITIGATIONS FOR HOSTING A SAFETY CRITICAL APPLICATION ON AN UNCONTROLLED DATA PROCESSING DEVICE

(71) Applicant: ABBOTT DIABETES CARE INC., Alameda, CA (US)

(72) Inventors: Glenn H. Berman, Alameda, CA (US); Hung Dinh, San Leandro, CA (US); Michael R. Love, Pleasanton, CA (US); Mark K. Sloan, Redwood City, CA (US)

(21) Appl. No.: 14/814,279

(22) Filed: Jul. 30, 2015

Related U.S. Application Data
(60) Provisional application No. 62/031,544, filed on Jul. 31, 2014.

(51) Int. Cl. G06F 19/00; H04L 29/08

(52) U.S. Cl. CPC G06F 19/3418; H04L 67/12

(57) ABSTRACT

Methods and systems for validating safety critical applications (SCAs) on uncontrolled data processing devices (UDPDs) are provided. Various combinations of checks including validation of safety critical features, validation of SCA-UDPD compatibility, and resource management are executed at various times to ensure the SCA operates properly on the device. The operation of the SCA on the UDPD may be controlled accordingly.

### CROSS-REFERENCE TO RELATED APPLICATIONS

This application claims the benefit of and priority to U.S. provisional application Ser. No. 62/031,544, filed Jul. 31, 2014, which is incorporated by reference herein in its entirety and for all purposes.

### BACKGROUND

Safety critical systems are systems whose failures or malfunctions may result in significantly detrimental consequences such as death or injury to persons, severe damage or loss to equipment or to environment. Medical systems are an example of safety critical systems that require a certain level of confidence that the system will operate and continue to operate properly. Medical systems may detrimentally affect a user's health and well-being if not operating properly or not known to be operating properly. This is especially true for medical systems that provide users with health-related diagnostic or therapeutic information. Inaccuracies or significant delays in reporting such diagnostic information may potentially lead to injury or death of a user.

A safety critical application (SCA) may be run in an open, uncontrolled shared data processing device such as a smart phone, PC, or web server. As such, the SCA may have limited control over changes to its environment, such as which applications are running in the background, incoming calls, updates to the operating system, and so forth.

### SUMMARY

Methods and systems for validating safety critical applications (SCAs) on uncontrolled data processing devices (UDPDs) are provided. Various combinations of checks including validation of safety critical features, validation of SCA-UDPD compatibility, and resource management are executed at various times to ensure the SCA operates properly on the device. The operation of the SCA on the UDPD may be controlled accordingly.

These and other objects, advantages, and features of the present disclosure will become apparent to those persons skilled in the art upon reading the details of the present disclosure as more fully described below.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Included in the drawings are the following figures:

FIG. 1 provides a block diagram of a safety critical system having a user data processing device (UDPD) in communication with an on-body unit, according to some aspects of the present disclosure.

FIG. 2 provides a block diagram of an on-body unit of a safety critical system, according to some aspects of the present disclosure.

FIG. 3 provides a block diagram of an on-body unit having stored reference data, according to some aspects of the present disclosure.

FIG. 4 provides a block diagram of a communication device in communication with an analog reference device, according to some aspects of the present disclosure.

FIG. 5 provides a flow diagram depicting safety critical features, according to some aspects of the subject methods.

FIG. 6 provides a flow diagram depicting validation of one or more safety critical features, according to some aspects of the subject methods.

FIG. 7 provides a flow diagram depicting validation of one or more safety critical features, according to some aspects of the subject methods.

FIG. 8 provides a flow diagram depicting validation that UDPD operating system has been tested for the application, according to some aspects of the subject methods.

FIG. 9 provides a flow diagram depicting validation of compatibility between the application and the UDPD operating system, according to some aspects of the subject methods.

FIG. 10 provides a flow diagram depicting registration prior to enabling safety critical features, according to some aspects of the subject methods.

FIG. 11 provides a flow diagram depicting registration prior to installing the application, according to some aspects of the subject methods.

FIG. 12 provides a flow diagram depicting disabling additional application(s) while running safety critical feature(s) of application, according to some aspects of the subject methods.

FIG. 13 provides a flow diagram depicting disabling incoming calls while running safety critical feature(s) of application, according to some aspects of the subject methods.

FIG. 14 provides a flow diagram depicting termination of interrupted safety critical feature(s) and restarting interrupted safety critical feature(s), according to some aspects of the subject methods.

FIG. 15 provides a flow diagram depicting safety critical features, according to some aspects of the subject methods.

### DETAILED DESCRIPTION

Before embodiments of the present disclosure are described, it is to be understood that the present disclosure is not limited to particular aspects described, as such may, of course, vary. It is also to be understood that the terminology used herein is for the purpose of describing particular aspects only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the present disclosure. The upper and lower limits of these smaller ranges may independently be included or excluded in the range, and each range where either, neither or both limits are included in the smaller ranges is also encompassed within the present disclosure, subject to any specifically excluded limit in the stated range. Where the stated range includes one or both of the limits, ranges excluding either or both of those included limits are also included in the present disclosure.

Unless defined otherwise, all technical and scientific terms used herein have the same meaning as commonly understood by one of ordinary skill in the art to which the present disclosure belongs. Although any methods and materials similar or equivalent to those described herein can be used in the practice or testing of the methods, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As used herein and in the appended claims, the singular forms “a”, “an”, and “the” include plural referents unless the context clearly dictates otherwise. Thus, for example, reference to “a firmware update” includes a plurality of such firmware updates and reference to “the firmware update” includes reference to one or more firmware updates and equivalents thereof known to those skilled in the art, and so forth.

It should be appreciated that the term “enabling” is used broadly herein and may include allowing, permitting, unlocking, etc., in some instances. Further, it should be appreciated that the term “preventing” is used broadly herein and may include restricting, disabling, locking, etc., in some instances.

The publications discussed herein are provided solely for their disclosure prior to the filing date of the present application. Nothing herein is to be construed as an admission that the present disclosure is not entitled to antedate such publication by virtue of prior invention. Further, the dates of publication provided may be different from the actual publication dates which may need to be independently confirmed.

Safety Critical Systems and Open Systems—

Safety critical systems are systems whose failures or malfunctions may result in significantly detrimental consequences such as death or injury to persons, severe damage or loss to equipment or to the environment. In certain embodiments of the present disclosure, a safety critical application (SCA) may be run on an open user data processing device (UDPD) such as a smart phone, a tablet computer, a smart watch, or the like, rather than on a dedicated hardware platform.

Some of what distinguishes an open system from a closed system include: hardware function is typically maintained and monitored by software outside of the client application; the client application runs on top of layers of software (e.g., the operating system) that are created and maintained by entities other than those creating and maintaining the client application; and multiple client applications must co-exist together.

In typical usage the user may apply software updates to the vendor supplied software layers independent of updating the client application. When validating a client application one can only validate the usage with the layers as they exist at the time. When updates to these layers are applied, the newly updated software layers may have bugs or the client application may be incompatible with the functions and capabilities of the new software layers. Multiple client applications may exist on the UDPD. These applications may have to share resources and peripherals. If a particular application does not behave well it may affect the function of other applications.

Aspects of the present disclosure include methods by which a user of the UDPD can verify that the hardware and software operating environment are adequately functioning to support the safe operation of the SCA.

In certain aspects, the data path referred to in the subject embodiments may include any of the following: sensor, communication device (e.g., “puck”), transceiver of communication device (e.g., patch radio), transceiver of UDPD (e.g., smart phone radio), wireless interface software, UDPD operating system, SCA running on UDPD, UDPD display drivers, UDPD display, UDPD internet interface, web server, cloud database and software. Between each successive item there is an interface. Parts of this data path may operate in an uncontrolled environment. For example, any combination of the transceiver of UDPD (e.g., smart phone radio), wireless interface software, UDPD operating system, SCA running on UDPD, UDPD display drivers, UDPD display, UDPD internet interface, web server, cloud database and software may operate in an open (uncontrolled or partially-controlled) environment.

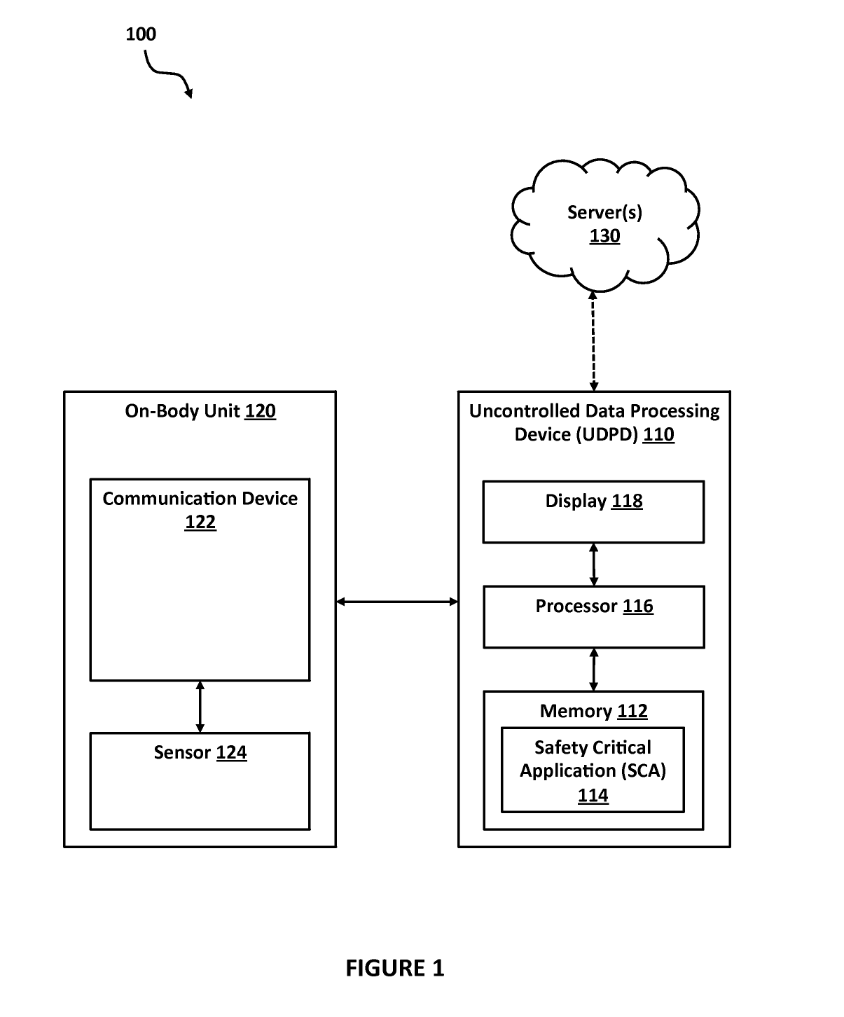

FIG. 1 provides a block diagram of a safety critical system having a uncontrolled data processing device (UDPD) 110 in communication with an on-body unit (OBU) 120, according to some aspects of the present disclosure. In certain aspects, the system 100 may be an in vivo analyte monitoring system capable of measuring and reporting the levels of one or more analytes (e.g., glucose, ketone bodies, insulin, etc.) in a user.

The UDPD 110 may be any data processing device used by an end user, such as a mobile device (e.g., tablet, mobile phone), laptop, PC, and so forth. Examples UDPDs include, personal computers (e.g., desktop, notebook, etc.), mobile/smart phones, smart watches, or tablet computers (any of which may run on an operating system (e.g., an Android®-, iOS-, Windows-based, or other operating system), personal digital assistants (PDAs), digital music player (e.g., iPod®), etc. Additional information and details regarding example uncontrolled data processing devices (e.g., iPhone®) are described in US Patent Application Publication No. US2008/0122796 published May 29, 2008 entitled “Touch Screen Device, Method, and Graphical User Interface for Determining Commands by Applying Heuristics”, the entirety of which is incorporated herein by reference for all purposes.

The UDPD 110 includes a memory 112 (e.g., a non-transitory computer readable medium), such as non-removable memory and/or removable memory. Examples of non-removable memory include RAM, ROM, flash memory, a hard disk, or other well-known memory storage technologies. Examples of removable memory include flash memory or a Subscriber Identity Module (SIM) card, which is well known in Global System for Mobile Communications (GSM) communication systems, or other well-known memory storage technologies, such as “smart cards”.

The memory 112 may store a safety critical application (SCA) 114, and optionally further data relating to the SCA 114 (such as raw data obtained from the on-body unit, results calculated from raw data, etc., as described in more detail herein). An SCA is an application whose failures or malfunctions may result in significantly detrimental consequences such as death or injury to persons, severe damage or loss to equipment or to environment. It will be appreciated that SCA 114 may be associated with a wide range of safety critical applications. In some aspects of the present disclosure, SCA 114 is a medically-related safety critical application. For example, SCA 114 may provide a user with health-related tools/features (e.g., information, computations, communications, etc.) associated with diagnosis, therapy and treatment, drug administration and dosage, data management (e.g., logs, records, history, graphs, charts, reports, etc.), etc.

In some aspects of the present disclosure, SCA 114 is an application associated with analyte monitoring and/or determination. Example features of SCA 114 may include, for example, one or more of the following: determining analyte amounts or concentrations from a sample (e.g., saliva, blood, interstitial fluid, other bodily fluid, etc.); receiving measurement data; managing and/or processing measurement data (e.g., logging measurements, providing warnings based on measurement values, providing alternative representations of data in the form of reports, graphs, charts, etc.); calculating drug dosage amounts (e.g., insulin bolus calculations) based on measurement data, exercise data, food intake, etc.; communicating with a remote device external to UDPD 110 (e.g., communicating drug dosage and/or administration data to a medication delivery device such as an insulin pump; receiving measurement data from a continuous in vivo monitoring device such as an implanted sensor; communicating with an analyte meter; etc.); other analyte monitoring feature described herein; etc. It should be appreciated that the above features listed are exemplary and that other features associated with analyte monitoring and/or determining may be implemented. In some aspects of the present disclosure, SCA 114 may be associated with glucose monitoring and/or determination. In some aspects of the present disclosure, SCA 114 may be associated with ketone monitoring and/or determination. Additional example applications related to analyte monitoring are provided in International Patent Publication No. W02010091102, entitled, “Multi-Function Analyte Test Device and Methods Therefor”, the disclosure of which is incorporated herein by reference in its entirety for all purposes.

The SCA 114 may be installed on UDPDs communicating with elements (e.g., adapters) and/or modules that provide additional functionality to a UDPD running a SCA. Examples and additional information of adapters used with UDPDs are described in U.S. Patent Application Publication No. US2011/0256024, the disclosure of which is incorporated herein by reference in its entirety for all purposes. Examples of analyte monitoring modules used with UDPDs are also described in U.S. Pat. No. 7,041,468 issued on May 9, 2006 titled “Blood Glucose Tracking Apparatus and Method” and in US Patent Application Publication No. US2004/0245534 published Dec. 16, 2004 titled “Glucose Measuring Module and Insulin Pump Combination”, the disclosures of which are incorporated herein by reference in their entireties for all purposes. The SCA 114 or any other additional applications/modules stored in the memory 112 may comprise machine-/processor-executable instructions to perform any methods described herein.

The memory 112 may further store data and/or code for running the operating system (not shown) and application(s) in addition to the SCA 114. Example data can include web pages, text, images, sound files, image data, video data, or other data sets to be sent to and/or received from one or more network servers or other devices via one or more wired or wireless networks. The memory 112 can be used to store a subscriber identifier, such as an International Mobile Subscriber Identity (IMSI) and/or an equipment identifier, such as an International Mobile Equipment Identifier (IMEI). Such identifiers can be transmitted to a network server to identify users and equipment.

The UDPD 110 may support one or more input devices, microphone (e.g., capable of capturing voice input), camera (e.g., capable of capturing still picture images and/or video images), physical keyboard, buttons and/or trackball and one or more output devices, such as a speaker, a display, and so forth. In certain aspects, the UDPD may include a display 118 (e.g., such as a touchscreen display capable of capturing finger tap inputs, finger gesture inputs, multi-finger tap inputs, multi-finger gesture inputs, and/or keystroke inputs from a virtual keyboard or keypad) coupled to the processor 116.

The mobile device may further include at least one input/output port, a power supply, a satellite navigation system receiver, such as a Global Positioning System (GPS) receiver, sensors, such as, for example, an accelerometer, a gyroscope, a compass, or an infrared proximity sensor for detecting the orientation or motion of the UDPD, a transceiver or transceiver/receiver (for wirelessly transmitting analog or digital signals) and/or a physical connector, which can be a USB port, IEEE 1394 (FireWire) port, and/or RS-232 port. The illustrated components are not required or all-inclusive, as any of the components shown can be omitted and other components can be added.

In certain aspects, the UDPD 110 may include one or more wireless modems coupled to one or more antennas (not shown) and can support two-way communications between the processor 116 and external devices such as on-body unit 120, as is well understood in the art. The modem may include, for example, a Bluetooth-compatible modem, a near field communication (NFC) compatible modem, a WiFi-compatible modem, etc., for communicating at short range with an external Bluetooth-equipped device or a local wireless data network or router. In certain aspects, the UDPD includes an NFC compatible modem that is capable performing ISO/EiC standards such as ISO/IEC 14443, ISO/IEC 15693, ISO/IEC 18092, (also known as ECMA standards).

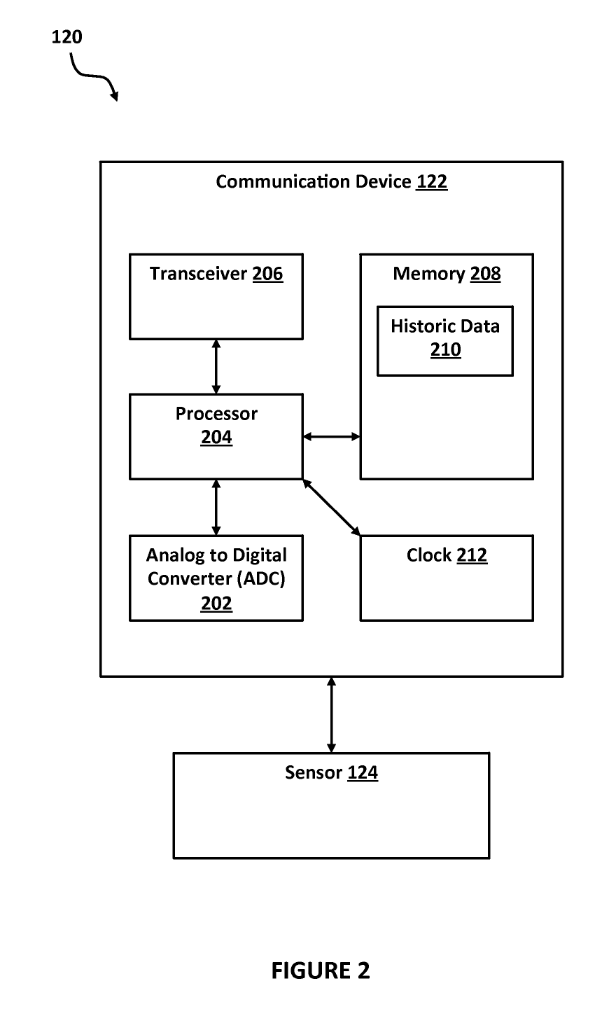

The on-body unit 120 includes a communication device 122 capable of communicating (e.g., according to any of the above standards) with the UDPD 110. The on-body unit 120 may be coupled to the UDPD 110 by a wired connection (e.g., USB, ethernet, or any other suitable wired technology) or wireless technologies (e.g., near field communication (NFC), Bluetooth, infrared (IR), radio frequency identification (RFID), or any other suitable wireless technology). The communications device 122 may be coupled to a sensor 124, and may be configured to obtain one or more signals from the sensor 124, e.g., as described in more detail in the discussion of FIG. 2 herein. The sensor 124 may provide an analog signal based corresponding to the level (e.g., concentration) of an analyte (e.g., such as glucose). The sensor 124 may be, for example, an implanted or partially implanted glucose sensor for continuous glucose measurement (CGM) or glucose on demand (GOD) applications.

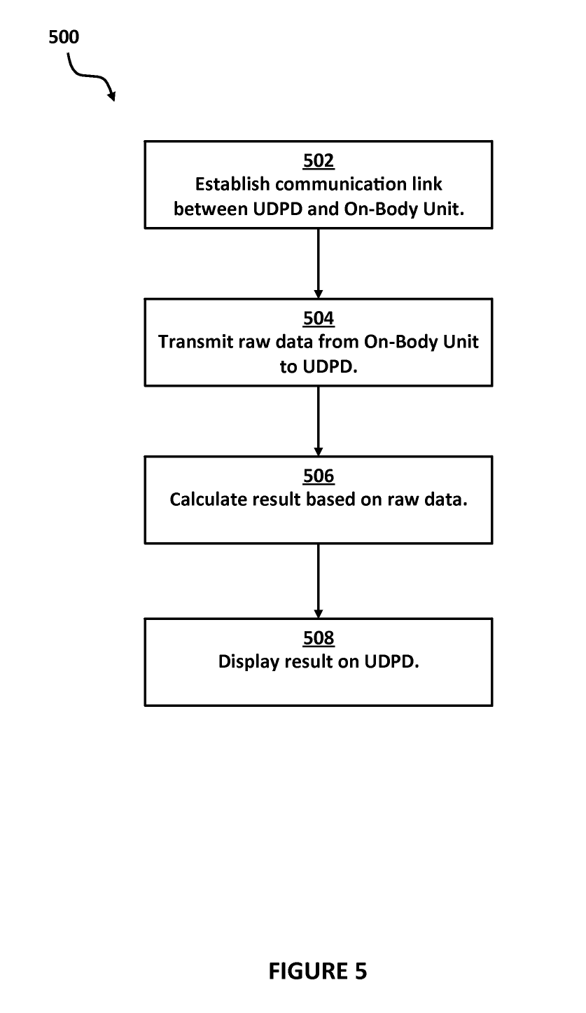

In certain aspects, the processor 116 may execute the SCA 114 to establish a communication link between the UDPD 110 and the communication device 122 of the on-body unit 120. The UDPD 110 may obtain raw data from the on-body unit 120 and calculate a result based on the raw data, e.g., as described in more detail in the discussion of FIG. 5 herein.

In certain aspects, the UDPD 110 may include a wireless modem configured for communication with one or more cellular and/or Internet networks, such as a cellular modem for communicating at long range with the mobile communication network or a wifi modem for communicating with a router. For example, the UDPD may be in communication with one or more server(s) 130 (e.g., cloud servers, website servers, etc.). The server(s) 130 may be accessible through a network, such as a mobile network or an Internet connection. In some embodiments the system includes data for storage and retrieval from the server(s) 130. In some embodiments the data stored in the Cloud can be viewed and analyzed on other open systems, such as a PC or Tablet.

FIG. 2 provides a block diagram of the on-body unit 120 (e.g., of FIG. 1) of a safety critical system, according to some aspects of the present disclosure. As discussed previously, the on-body unit 120 may include the communication device 122 coupled to a sensor 124. The sensor 124 may be configured to provide a signal (or multiple signals) to the communication device 122. In certain aspects, the signal may be an analog signal, such as a raw sensor current (e.g., resulting from glucose oxidation), a signal corresponding to temperature (e.g., skin temperature, air temperature), and so forth. The communication device 122 may include an analog to digital converter (ADC) 202 configured to produce a digital signal (referred to herein as a “raw data” read or measurement) from an analog signal obtained from the sensor 124.

The communication device 122 may further comprise a processor 204 configured to transmit the raw data, through a transceiver 206 (or transmitter) to the UDPD. Alternatively or in addition, the processor 204 may be configured to store the raw data in a memory 208 of the communication device 122, e.g., as historic data 210. In certain aspects, the processor 204 may associate a time stamp with a raw data “read” or “measurement” (e.g., using a time provided by a clock 212 of the communication device 122). The processor may be configured to transmit a recent raw data read and/or historic data to the UDPD upon receiving a request (e.g., executable instructions) for said data from the UDPD.

The communication device 122 and/or sensor 124 may have additional components not shown herein but known in the art, such as an alarm configured to notify a user when a signal provided by the sensor 124 falls above or below a given threshold.

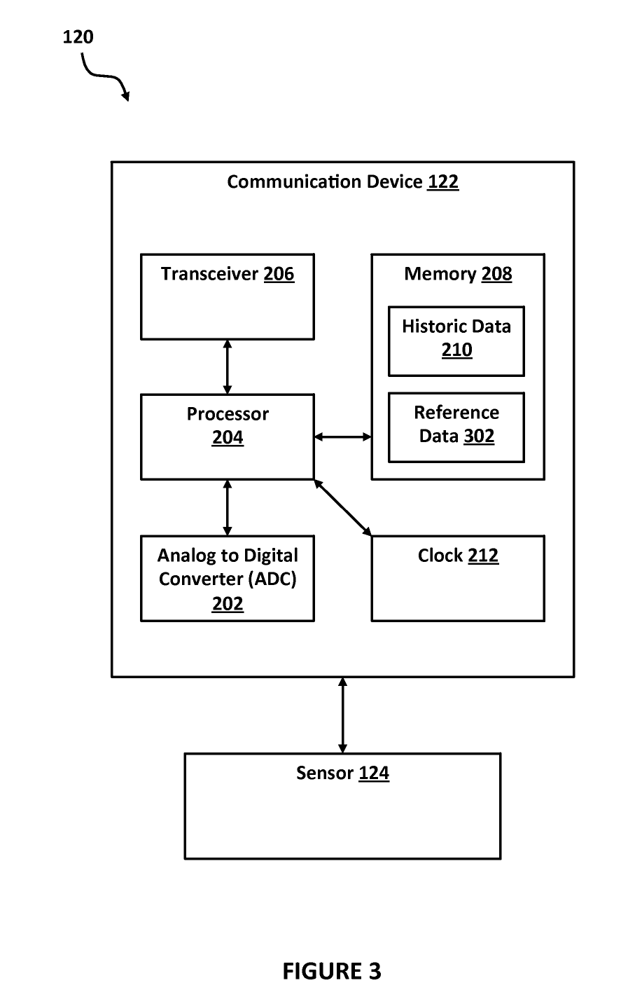

FIG. 3 provides a block diagram of an on-body unit 120 (e.g., of FIG. 1 or 2) having stored reference data 302, according to some aspects of the present disclosure. The communication device 122 of the on body unit may store reference data 302 in a memory 208. The reference data 302 of FIG. 3 may include digital data similar to a raw data read. The reference data 302 may be used to validate safety critical features, e.g., through comparison of a result calculated from the reference data 302 to an expected result associated with the reference data 302, as discussed further herein. In certain aspects, the memory 208 may store the expected result corresponding to the reference data 302.

In certain aspects, the reference data 302 may be stored on the communication device in its original form (e.g., as purchased), and may later be overwritten (e.g., by historic data 210). Alternatively, the reference data 302 may be stored indefinitely in the memory 208 so as to be used multiple times for validation of safety critical features. In certain aspects, the memory 208 may store a “seed” (i.e., a smaller amount of data than a normal raw data read, from which reference data 302 may be derived). For example, the seed may be an ID of the communication device 120 that can be processed using an algorithm provided by the SCA (e.g., the SCA 114 of FIG. 1 to obtain the reference data 302. The seed or reference data 302 may be included with a data packet (e.g., that also includes actual raw data such as historic data, a recent data read, etc.) sent to the UDPD.

For example, the reference data 302 may include various test data to be used in the checks (e.g., predetermined input data or requests) as well as any data, results, timing values, etc., that are acceptable or expected to result from various checks to indicate proper operation of the UDPD. It should be understood that some parameters and requirements may encompass ranges and/or include tolerances which allow for some level of deviation.

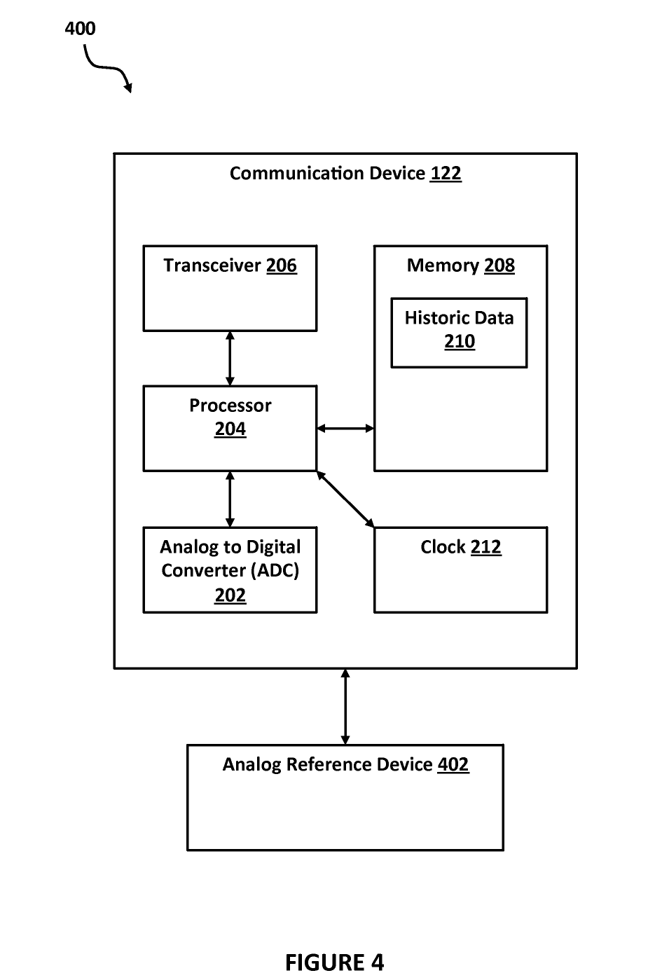

FIG. 4 provides a block diagram of a communication device 122 in communication with an analog reference device 402, according to some aspects of the present disclosure. In embodiments related to FIG. 4, the communication device 122 is not coupled to the sensor 124 shown, for example, in FIG. 1. Instead, the communication device 122 is coupled to an analog reference device 402 which provides a signal (e.g., analog signal) similar to the signal that would have been provided by the sensor 124. By “similar” is meant in the same format as a raw data read. Optionally, the analog reference 402 may also provide an identifying signal that distinguishes the analog reference 402 from the sensor 124. The signal provided by the analog reference device 402 may correspond to an expected result. The expected result may be stored in the memory 208, stored in the memory of the UDPD, stored on a server (e.g., the server(s) 130 of FIG. 1), or known by the user of the UDPD. The communication device 122 may obtain reference data from the signal provided by the analog reference 402. A result calculated from the reference data (e.g., calculated by the UDPD) may be compared to the corresponding expected result, to verify safety critical features of the SCA, as discussed further herein.

In certain aspects, the analog reference device 402 may be a sensor capable of detecting analyte in a user, that also may be configured to provide the analog reference signal (e.g., while in a “special mode”).

Safety Critical Features—

In some aspects of the present disclosure, the safety critical application (SCA) may include instructions to perform one or more safety critical features.

FIG. 5 provides a flow diagram depicting safety critical features of the subject methods, according to some aspects of the present disclosure. As discussed above, safety critical features include features (e.g., of an SCA application) whose correct execution is important to the safety of a person (e.g., the user of the UDPD). In certain aspects, the SCA run on the UDPD obtains raw data from the on-body unit and calculates a result (e.g., the level of a biomarker, recommendation as to dosage of an application) that is displayed on the UDPD. Multiple safety critical features must be executed correctly in order to display a correct result. Failure to perform these safety critical features correctly may result in an incorrect result being displayed, compromising the health of the user of the UDPD.

In certain methods of the present disclosure, safety critical features include step 502 of establishing a communication link between the UDPD and the on-body unit. The communication link may be established by either the UDPD or the on-body unit. For example, the user of the UDPD may open the SCA which may initiate communication with the on-body unit (e.g., as described above). Alternatively, a signal provided by or obtained from the sensor may trigger the communication device of the on-body unit to initiate communication with the UDPD. The communication may be according to any of the types (e.g., Ethernet, Bluetooth, NFC, etc.) and standards described elsewhere herein or known in the art.

The safety critical features may further include step 504 of transmitting raw data from the on-body unit to the UDPD. Step 504 may include the UDPD sending a request to the on-body unit for raw data (e.g., a recent raw data read, historic data, etc.). Step 504 may further include the communications device of the on-body unit obtaining raw data (i.e., a recent raw data read) from one or more signals provided by the sensor.

The safety critical features may further include step 506 of the UDPD calculating a result based on the raw data obtained from the on-body unit. As discussed previously, the result may be an estimation of the current amount (concentration) of a biomarker in the user's blood (e.g., glucose), a history of the levels of the biomarker in the user's blood (such as over a number of hours, days, etc.), and/or other physical measurements (e.g. blood pressure, heart rate, body temperature, etc.). The result may be a recommended dosage or timing of a medication, health coaching advice (such as to decrease sugar intake, increase exercise, etc.), or any other suitable feedback.

Specific calculations may vary depending on the specific safety critical features implemented within SCA. For example, calculations for analyte monitoring applications may include, but are not limited to, computing analyte (e.g., glucose) measurements, calculating medicine dosages and/or administration times (e.g., insulin dosages from received glucose measurements), executing various other therapy-related algorithms (e.g., trending calculations, various alert determinations, etc.), and/or other safety critical computations that are applicable to analyte monitoring.

The safety critical features may further include step 508 of displaying the result on the UDPD. For example, any combination of the current amount of a biomarker, historical levels of the biomarker, and other physical measurements may be presented on the display (e.g., as a value, graph, etc.). Alternatively or in addition, the result may be presented as an audio message (e.g., through speakers of the UDPD).

In certain aspects, the on-body unit may monitor glucose levels. For example, in step 504, the UDPD may request a recent raw data read, after which the communication device may obtain a raw data read from signals (e.g., related to glucose oxidation current, air temperature, and/or skin temperature) provided by the sensor. The communication device may then send the raw data read to the UDPD. In step 506, the UDPD may calculate a result (e.g., glucose level) based on the raw data read. In step 508, the UDPD may display the result on the display. The disruption or incorrect execution of any of steps 502 to 508 may compromise the safety of the user.

Validation of Safety Critical Features—

Method steps are provided for validating proper function of safety critical features. In certain aspects, reference data may be used to calculate a result, and the result may be compared to a predetermined expected result for the given reference data.

If, for example, it is determined that SCA does not perform the calculations accurately (e.g., results of the calculation do not match an expected result), then the SCA is not operating properly on UDPD. SCA may then be prevented from operating freely on UDPD. When operating freely, the SCA may perform safety critical features. When prevented from operating freely, the SCA may not perform safety critical features, although it may perform non-safety critical features (such as displaying logged results that have been correctly calculated).

In some instances, a determination that SCA functions properly on UDPD requires at least a determination that SCA performs calculations accurately (e.g., a match between the result of the computation and the reference computational data). It should be appreciated that although a condition is required for SCA to function properly, that does not necessary mean that SCA functions properly if that condition is met—other conditions may also be required to be met. For example, in some instances, in order for SCA to function properly it may be required that SCA performs computations accurately (e.g., results of the computation match the reference computational data), as well as be required that SCA performs computations in a timely manner. Thus, the occurrence of one condition alone does not necessarily mean SCA functions properly. If, for example, it is determined that SCA performs computations accurately (e.g., results of the computation match the reference computational data), then other checks and/or test routines may be initiated (or if no other checks and/or test routines are required to be executed, then SCA may be permitted to operate freely).

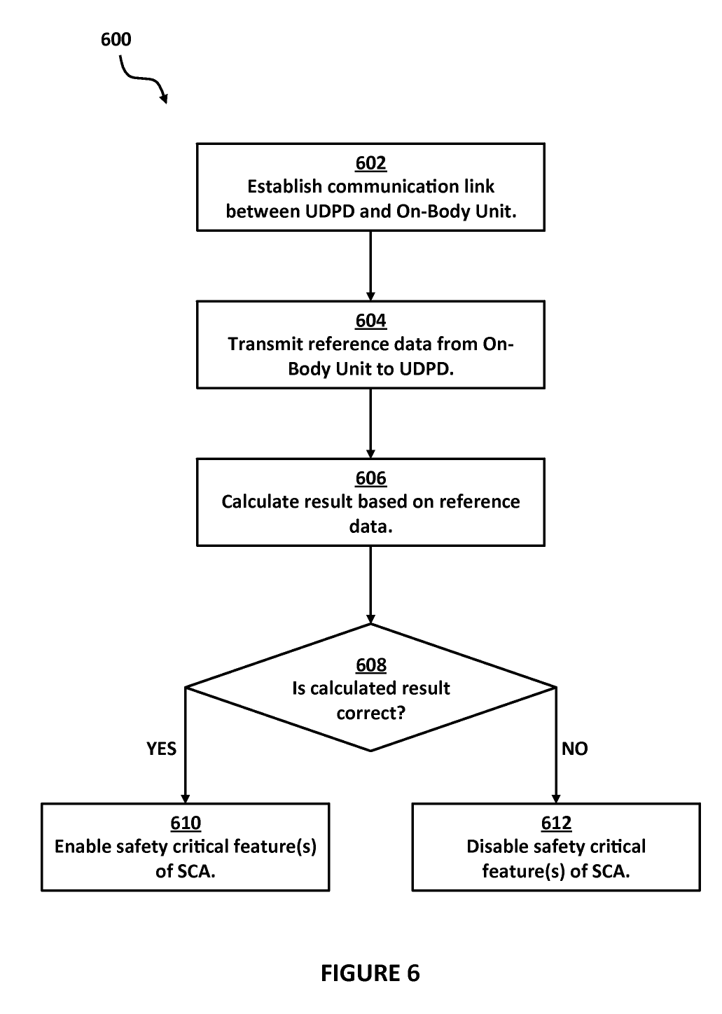

FIG. 6 provides a flow diagram depicting validation of one or more safety critical features, according to some aspects of the subject methods. Step 602 may be similar to step 502 of FIG. 5. In step 604, the on-body unit transmits reference data to the UDPD. As discussed in FIGS. 2 to 4, the reference data may be any data similar to a raw data read and having an associated expected result. The reference data may be provided by, for example, the on-body unit shown in FIG. 3 or FIG. 4.

In certain aspects, the reference data may be an analog reference data (e.g., as seen in FIG. 4). The communication device may obtain the analog reference data from a signal with a known analog value provided by an analog reference device. Step 602, where the reference data is an analog reference data, may be performed any time the communication device is not connected to the body. The user may simply couple the communication device to the analog reference device.

In certain aspects, the reference data may be digital reference data (e.g., as seen in FIG. 3). The communication device may store the digital reference data that the Reader can request (e.g., while in a “special mode”). The UDPD may obtain the digital reference data from the communication device prior to the communication device being coupled to the sensor.

The digital reference data may be pre-loaded on the communication device, and may be overwritten when actual raw data obtained from the sensor is stored on the memory of the communication device. This is a way to provide more special packets without adding dedicated memory.

In comparison to the analog reference described above, a digital reference would not validate the ability of the communication device to obtain accurate data from an analog signal. In certain embodiments, the reference data may be provided to the UDPD by a device other than the communication device, such as a control device specifically designed to provide digital reference data to the UDPD.

In certain aspects, the reference data may be a “seed” (more compact than a raw data read), such as an ID of the puck or a header of a packet (e.g., that includes raw data obtained from the sensor) sent to the UDPD. The SCA may provide an algorithm to derive digital reference data (in the same format as a raw data read) from the “seed”.

In step 606 the UDPD calculates a result based on the reference data. The on-body unit may also transmit an expected result associated with the reference data. Alternatively, the expected result may be stored in the memory of the UDPD, provided to the UDPD by the server(s), or known by the user of the UDPD (e.g., the expected result may be printed on instructions included with the on-body unit or printed on the on-body unit).

In step 608, the calculated result is compared to the associated expected result, to determine whether the calculated result was correct. Prior to initiating safety critical features (e.g., the steps shown in FIG. 5), the user of the UDPD may verify that the UDPD produces this published result. This verifies the proper function of the software and hardware for the entire data path from sensor to the UDPD display. Alternatively, the UDPD may determine whether the calculated result was correct without the input of the user (e.g., by comparing to an expected result). A fault anywhere along this path is bound to produce an incorrect result. In certain aspects, the user may be instructed to connect the UDPD to the server(s) (e.g., such as a cloud database accessed through a mobile network or Internet connection). The user may then verify that the same value reached the server (e.g., cloud database) by displaying the glucose reading from a web page which draws data from the server.

The calculated result may be considered correct when it matches the expected result. In certain embodiments, such as when the reference data is based on a signal provided by an analog reference device (as seen in FIG. 4), the calculated result may be considered correct when it is within a certain range of the expected result, such as within 1% or less, 2% or less, 5% or less, 10% or less, 15% or less, 20% or less, or 25% or less of the expected result.

When the calculated result is correct, the method may further include enabling safety critical feature(s) (such as step 502, 504, 506, 508, or any combination thereof) as recited by step 610. When the calculated result is not correct, the method may further include disabling safety critical feature(s) (such as step 502, 504, 506, 508, or any combination thereof) as recited by step 612. Alternatively or in addition, when the calculated result is not correct, the method may include providing an error message and/or repeating any of steps 602 through 608.

In certain aspects, verification tests may be confined to the UDPD. For example, the reference data may be stored in the memory of the UDPD. This reference data may produce a known published value (e.g., an expected result) when the SCA is put into a test mode, thereby validating the use of the SCA within the UDPD environment.

In an alternative to step 604 recited above, a communication device may transmit reference data to the UDPD, where the communication device is not part of an on-body unit having a sensor. In other words, the communication device is designed solely to provide the reference data to the UDPD, and not to obtain raw data from a sensor. This alternative embodiment verifies that the UDPD can communicate with a communication device, but does not verify communication function of the normal communication device coupled to the sensor.

As discussed above, aspects of the present disclosure include a method for hosting a safety critical application on an uncontrolled data processing device, the method including: transmitting reference data from an on-body unit (OBU) to an uncontrolled data processing device (UDPD), wherein the UDPD comprises a processor, a non-transitory computer readable medium, and a safety critical application (SCA) installed on the non-transitory computer readable medium that causes the processor to: calculate a value based on the reference data and compare the calculated value with a reference value; prevent the SCA from operating freely when the calculated value is different from the reference value; and permit the SCA to operate freely when the calculated value matches the reference value.

In certain aspects, the method may further include obtaining the reference data from an analog signal, prior to the step of transmitting. In certain aspects, the OBU does not include a sensor inserted into the body of a user.

Alternatively, the reference data may include digital reference data stored on a non-transitory computer readable medium of the OBU. A sensor of the OBU of the inserted into the body of a user prior to transmitting the digital reference signal from the OBU to the UDPD. The digital reference signal may include data pre-loaded on the OBU during manufacture of the OBU. Permitting the SCA to operate freely comprises overwriting the pre-loaded data corresponding to the reference signal with data corresponding to signal generated from a sensor of the OBU. In certain aspects, the OBU may be a control OBU that does not comprise a sensor. In certain aspects, the digital reference signal may be derived from an identification code associated with the OBU.

The step of preventing the SCA from operating freely may include disabling safety critical features of the SCA. The step of preventing the SCA from operating freely may further include enabling non-safety critical features of the SCA.

The method may further include placing the UDPD in a reference signal calculation mode, prior to transmission of the reference signal from the OBU to the UDPD.

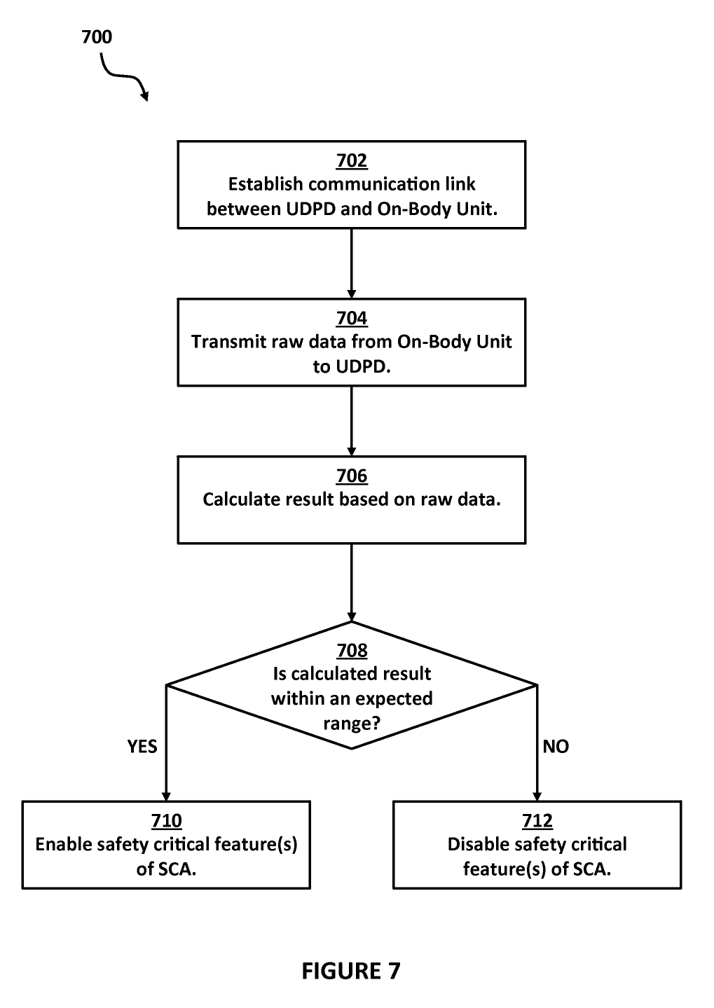

FIG. 7 provides a flow diagram depicting validation of one or more safety critical features, according to some aspects of the subject methods. Steps 702, 704, and 706 may be similar to steps 502, 504, and 506, respectively, from FIG. 5. In step 708, the UDPD determines whether the calculated result falls inside of or outside of an expected range. The expected range may be stored in the memory of the UDPD and/or provided by a server. The expected range may be a range of physically possible levels (e.g., of an analyte). For example, blood glucose levels of 100 mmol/L or 0.1 mmol/L may be outside the range of physically possible levels.

In certain embodiments, the UDPD may determine whether the raw data falls within or outside an expected range. For example, raw data that provides a skin temperature of 30° C. or 45° C. falls outside the range of physically acceptable levels. If the raw data is determined to be outside an expected range, the UDPD may disable safety critical features of the SCA, and may optionally provide an error message. The SCA may provide an algorithm that can identify corrupted data by identifying when it could not possibly reflect data originating from a physical source. Such an algorithm could run on the UDPD itself or on a server (e.g., in the cloud), if the necessary data is uploaded to the server. This method could be used to verify the correct operation of the SCA on the UDPD Itself.

When a calculated result or raw data is determined to be outside an expected range, the UDPD may instruct the user to take certain measures (e.g., close background applications, check connection between the communication device and the sensor). Alternatively or in addition, the UDPD may initiate one or more validation checks, such as the steps seen in FIG. 6.

In certain aspects, step 708 involves an algorithm that looks for natural variation and unnatural steps that exceed physiologic values. In one example, a module of the SCA that filters the overlapping data points may check to be sure that the overlapping data points match up, and that data points taken around the same time are not too different.

As discussed above, aspects of the present disclosure include a method for hosting a safety critical application on an uncontrolled data processing device, the method including: transmitting data from an on-body unit (OBU) to an uncontrolled data processing device (UDPD); calculating, using the UDPD, a value based on the transmitted data; comparing, using the UDPD, the calculated value to a range of possible physiologic values; preventing, using the UDPD, a safety critical application (SCA) installed on the UDPD from operating freely when the data falls outside the range of possible physiologic values; and permitting, using the UDPD, the SCA to operate freely when the data falls within the range of possible physiologic values.

The range of possible physiologic values may be based on historic values previously calculated using signals from a sensor of the OBU. Alternatively, the range of possible physiologic values may be predetermined and independent of historic values previously calculated using signals from a sensor of the OBU.

The step of preventing the SCA from operating freely may include disabling safety critical features of the SCA. The step of preventing the SCA from operating freely may further include enabling non-safety critical features of the SCA.

In some aspects of the present disclosure, a functional check may be executed to determine whether SCA functions properly on UDPD. For example, functional check may check whether SCA performs computations (e.g., calculations, measurements, etc.) accurately on UDPD; whether SCA displays data properly on a display of UDPD; and/or whether SCA communicates properly via UDPD with an external device; and/or whether SCA performs these and/or other safety critical activities in a proper amount of time.

A delay in performing an activity may have detrimental consequences and may indicate improper operating of SCA on UDPD. For example, a significant delay in providing a computation for a glucose measurement may be sufficient to determine that SCA is not operating properly on UDPD. Further, it should be appreciated that in some instances, performing an activity such as a computation too quickly may be indicative of improper functioning as well. Functional check may also, for example, check whether data for SCA is displayed properly on a display of UDPD; and/or whether SCA may communicate properly between UDPD and an external device.

If, for example, it is determined that SCA does not function properly, then functional check indicates that SCA does not operate properly on UDPD. SCA may then be prevented from operating freely on UDPD. If, for example, it is determined that SCA functions properly, then other checks may also be initiated as required (or if no other checks are required to be executed, then SCA may be permitted to operate freely).

Expected Time to Complete Calculation—

It is expected that the calculation of glucose can be accomplished in a set time. Exceeding this time limit would indicate either a corruption of the software, an interruption of the task by another process, or an incompatibility between the SCA and the UDPD. Setting time windows for safety critical features such as: transmitting data from the on-body unit to the UDPD, processing/calculating/storing the raw data, result, trends etc.; and displaying the result to the user.

A delay in performing an activity may have detrimental consequences and may indicate improper operating of SCA on UDPD. For example, a significant delay in providing a computation for a glucose measurement may be sufficient to determine that SCA is not operating properly on UDPD. Further, it should be appreciated that in some instances, performing an activity such as a computation too quickly may be indicative of improper functioning as well.

When completion of a safety critical feature exceeds a time limit (or falls outside an expected time range), the SCA may be prevented from operating freely on UDPD. Optionally further, the UDPD may display an error message. If, for example, it is determined that SCA functions properly, then other checks may also be initiated as required (or if no other checks are required to be executed, then SCA may be permitted to operate freely).

Validating Compatibility—

Certain configurations of the UDPD such as between the model and/or operating system may not be compatible, or may not be tested for compatibility with the SCA. In addition, certain additional applications stored in the memory of the UDPD, such as applications that run in the background and may consume resources (e.g., processing, RAM, etc.), may compromise the integrity of the above described safety critical features.

In certain aspects, the SCA may be restricted to a tested UDPD environment. For example, a list of operating systems and applications that the SCA may be known to be compatible or incompatible with may be maintained on the UDPD. This list could be updated from the Cloud (e.g., server(s)). The SCA may check this list prior to, for example: allowing the scan process to start; displaying a glucose value; or after any software updates or additions to the phone. The SCA may allow the scan or allow the value to be displayed depending on the result of the check.

In certain aspects, the UDPD may be configured to check for updates to the SCA, additional application(s), and/or the operating system of the UDPD. This may trigger running the various configuration and functional checks described herein.

In some instances, the environment check is implemented to check to see if the environment of UDPD has changed, which may be a possible indicator that SCA no longer operates properly on UDPD. In such cases, one or more additional validations described herein may be executed to confirm that SCA is operating properly on UDPD in the new environment.

Some applications may not be able to coexist on UDPD with SCA without compromising a safety critical aspect of SCA, or operation thereof, on UDPD. For example, a nonrelated program that is running may prevent or significantly delay SCA from access to a safety critical function such as displaying a test result, sounding an alarm, accessing wireless communication, etc. If these functions are safety critical features, the coexistence of the two programs on UDPD may pose safety critical issues that potentially prevent SCA from operating properly on UDPD and SCA may be prevented from operating freely.

Aspects of the present disclosure include a method for hosting a safety critical application on an uncontrolled data processing device, the method including: determining whether an operating system or version thereof of an uncontrolled data processing device (UDPD) is an operating system approved for use with a safety critical application (SCA); preventing, using the UDPD, the SCA from operating freely when the operating system or version thereof is not approved for use with the SCA; and permitting, using the UDPD, the SCA to operate freely when the operating system or version thereof is approved for use with the SCA.

Aspects of the present disclosure include a method for hosting a safety critical application on an uncontrolled data processing device, the method including: determining whether an uncontrolled data processing device (UDPD) environment is an approved UDPD for use with a safety critical application (SCA); preventing, using the UDPD, the SCA from operating freely when the UDPD environment is not approved for use with the SCA; and permitting, using the UDPD, the SCA to operate freely when the UDPD environment is approved for use with the SCA.

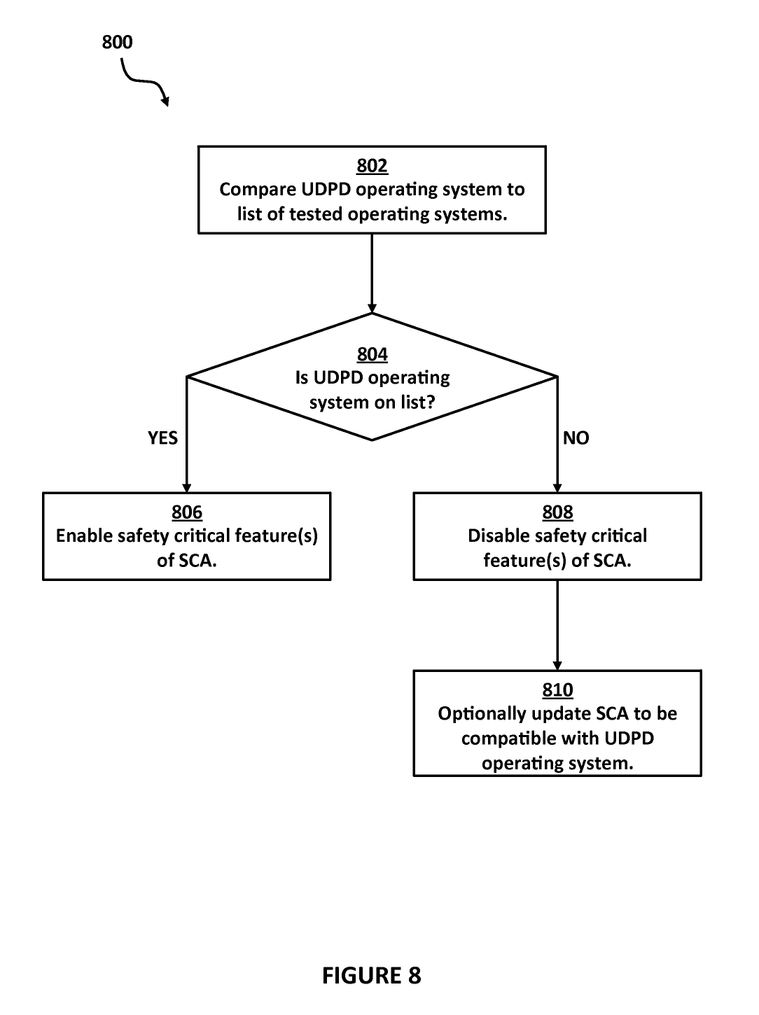

FIG. 8 provides a flow diagram depicting validation that the UDPD operating system has been tested for the application, according to some aspects of the subject methods. Step 802 includes comparing the UDPD operating system (OS) to a list of tested operating systems (i.e., operating systems which the SCA is known to be compatible with). In certain aspects, a list of tested operating systems may be downloaded to the memory when SCA is installed (e.g., as part of SCA). Alternatively or in addition, the SCA may provide instructions to compare the UDPD operating system to a list of operating systems obtained from the server(s). Step 802 may be initiated when the SCA is first installed, when a new operating system is installed, every time the SCA is run, the first time the SCA is run since the UDPD has been powered on, and so forth.

When the UDPD operating system is on the list, the UDPD may enable safety critical feature(s) of the SCA (e.g., steps 502, 504, 506, 508 or a combination thereof). When the UDPD operating system is not on the list, the UDPD may disable safety critical feature(s) of the SCA (e.g., steps 502, 504, 506, 508 or a combination thereof). Optionally further, the UDPD may provide an error message notifying the user that the SCA and the UDPD operating system are not or may not be compatible.

When the UDPD operating system is not on the list of tested operating systems for the given SCA, the method may further comprise updating the SCA (or the operating system) to be compatible, as recited in step 810. Updating may include identifying an SCA or operating system that is compatible, and initiating the update. Such steps may require user approval.

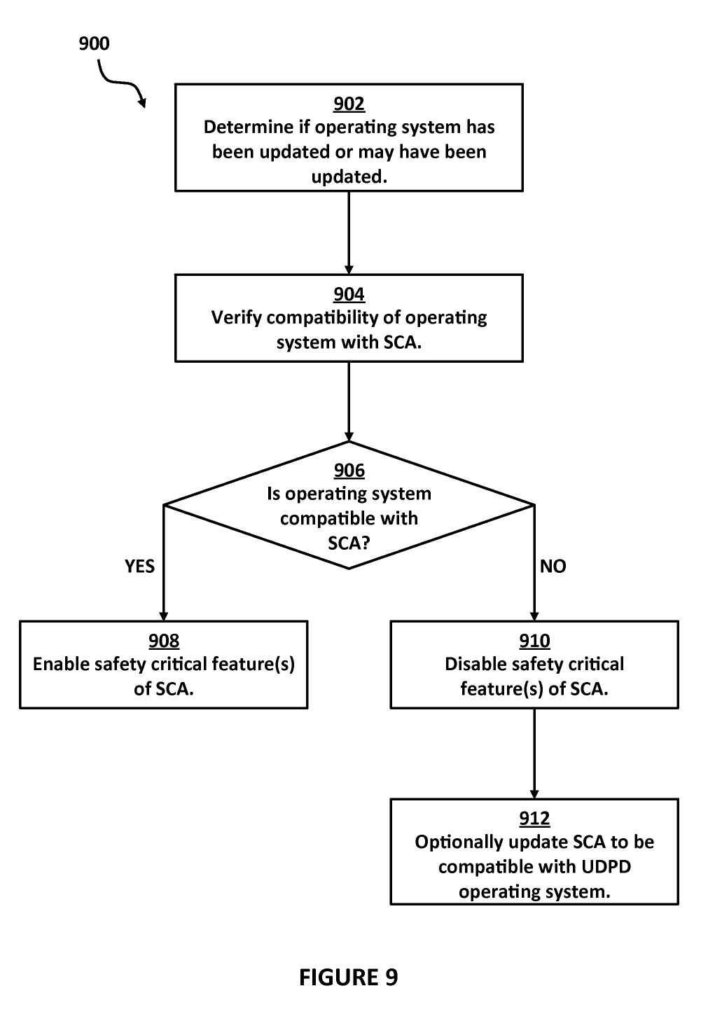

FIG. 9 provides a flow diagram depicting validation of compatibility between the application and the UDPD operating system, according to some aspects of the subject methods. The SCA may be configured to initiate a system check (e.g., whenever the SCA is run, the first time the SCA is run since the UDPD has been powered on, etc.) to determine if the UDPD operating system has been updated or may have been updated, as recited in step 902. In certain aspects, depending on the permission granted to the SCA by the current operating system for a given UDPD, the UDPD may be configured to automatically initiate step 904 when the UDPD operating system is updated. In step 904, the UDPD verifies compatibility of the operating system with the SCA. Step 904 may involve comparison to a list of tested operating systems for the given SCA (e.g., as recited by step 802 above). Alternatively, step 904 may involve validating safety critical features (e.g., as recited by step 602 to 608) above.

When the UDPD operating system is determined to be compatible with the SCA 144 (e.g., when the OS is matched to a list of tested operating systems as in FIG. 8, or when safety critical features are validated as in FIG. 6), the UDPD may enable safety critical feature(s) of the SCA (e.g., steps 502, 504, 506, 508 or a combination thereof), as recited in step 908. When the UDPD operating system is not determined to be compatible with the SCA, the UDPD may disable safety critical feature(s) of the SCA (e.g., steps 502, 504, 506, 508 or a combination thereof), as recited in step 910. Optionally further, the UDPD may provide an error message notifying the user that the SCA and the UDPD operating system are not or may not be compatible.

When the UDPD operating system is not on the list of tested operating systems for the given SCA, the method may further comprise updating the SCA (or the operating system) to be compatible, as recited in step 912. Updating may include identifying an SCA or operating system that is compatible, and initiating the update. Such steps may require user approval.

Registration—

In some aspects of the present disclosure, the SCA and/or the UDPD, UDPD operating system, etc., may be registered to ensure compatibility between the SCA and the UDPD configuration.

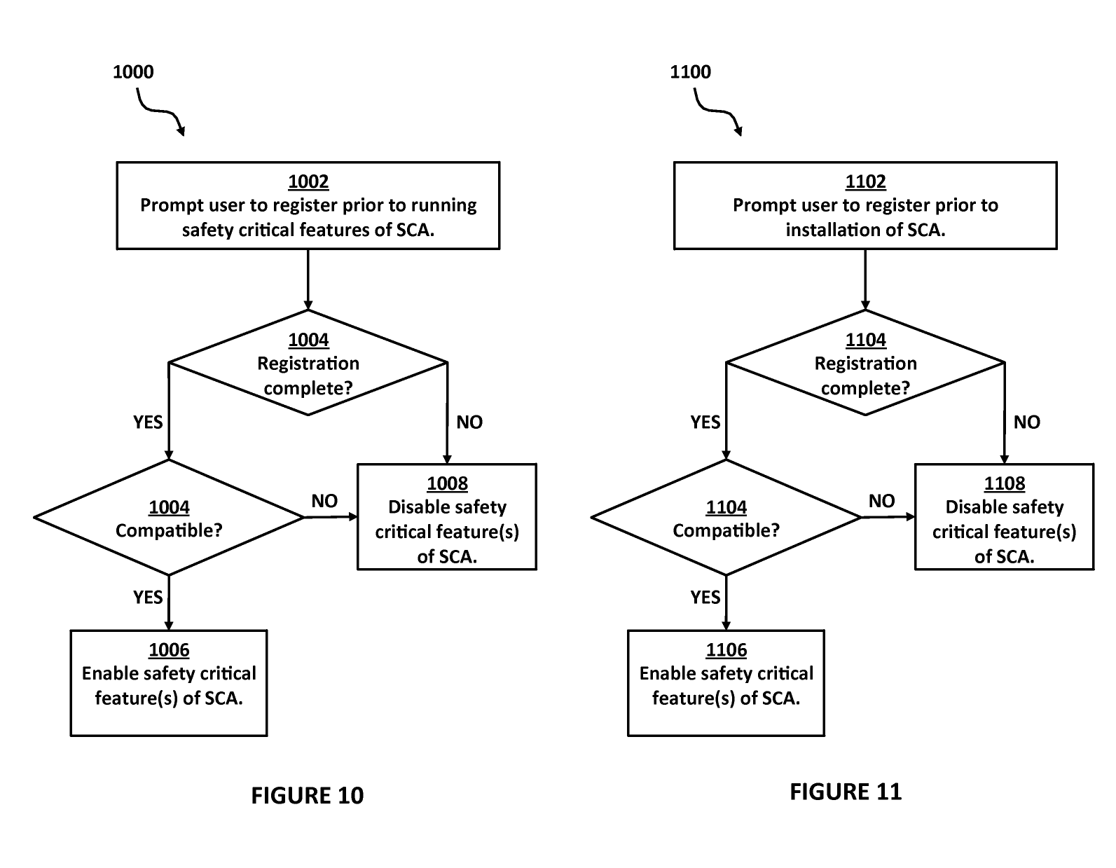

FIG. 10 provides a flow diagram depicting registration prior to enabling safety critical features, according to some aspects of the subject methods. In step 1002, the UDPD prompts the user to register the SCA prior to running safety critical features of the SCA. For example, when the user first opens an unregistered SCA, the UDPD may prompt the user to register the SCA. The prompt may be a pop-up window that the user may use to navigate to a website (e.g., of networked server(s)). Step 1002 may include prompting the user to input information such as UDPD model, UDPD operating system, personal information (e.g., identifying information such as name, contact information, relevant health information). In addition or alternatively, step 1002 may include uploading the results of a system check (e.g., UDPD model, operating system, additional apps, etc.) without the need for the user to manually input information. The information may be stored on the server(s). In addition, steps to validate compatibility of the SCA with the UDPD may be performed based on the information provided in the registrations. For example, the steps of FIG. 8 may be performed based on the UDPD operating system provided in step 1002.

Upon completion of the registration (e.g., provided compatibility was validated), the UDPD may enable safety critical feature(s) of the SCA as recited in step 1006. If the registration was not completed, or if compatibility was not validated, the UDPD may disable safety critical feature(s) of the application. Further, the user may be prompted to complete registration, or address a compatibility issue (e.g., by updating the UDPD operating system or SCA).

FIG. 11 provides a flow diagram depicting registration prior to installing the application, according to some aspects of the subject methods. Similar to FIG. 10, FIG. 11 relates to prompting the user to register the SCA. In step 1102, the UDPD prompts the user to register the SCA prior to installing the SCA. This can ensure that the SCA is only installed on a UDPD that is compatible with the SCA. When registration is complete (e.g., and if the SCA is determined to be compatible with the UDPD), installation of the SCA may be enabled. Installation may be enabled, for example, by providing a key (e.g., to decrypt the SCA), by providing permission to download the SCA from an online app store, etc. The key, or permission, may be withheld when either registration was not completed or when it is not determined whether the SCA and the UDPD are compatible.

Managing Resources—

The UDPD may have limited processing, RAM, wireless or NFC capabilities, etc., based on the UDPD mode, operating system, applications running in the background, incoming calls and/or messages, etc. Limitations to the resources available to the SCA may compromise one or more safety critical features. Detecting and/or preventing limitations to such resources may ensure/improve the proper functioning and/or reliability of safety critical features.

Certain aspects of the subject methods involve temporarily blocking incoming calls and/or messages (e.g., by activating an airplane mode) that could interrupt tasks during the scan, process/calculate, and display phases of the safety critical applications.

Aspects of the present disclosure include a method for hosting a safety critical application on an uncontrolled data processing device, the method including: transmitting data from an on-body unit (OBU) to an uncontrolled data processing device (UDPD); calculating, using the UDPD, a value based on the transmitted data; and blocking one or more functionalities of the UDPD during operation of the safety critical application (SCA).

In certain aspects, the UDPD may be a mobile phone, and blocking one or more functionalities of the UDPD may include blocking one or more functionalities selected from the group consisting of: the ability to receive phone calls, the ability to receive text messages, the ability to receive non-SCA application notifications, and combinations thereof.

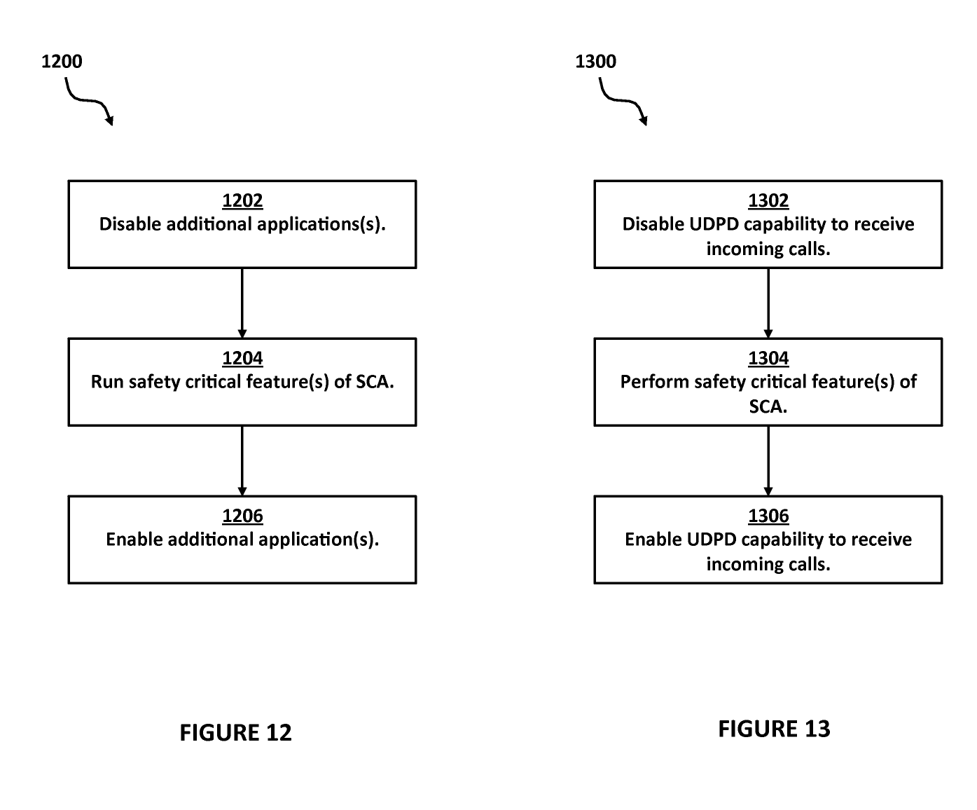

FIG. 12 provides a flow diagram depicting disabling additional application(s) while running safety critical feature(s) of application, according to some aspects of the subject methods. In certain aspects, depending on permissions given to the SCA, the UDPD may prevent additional applications (e.g., any other applications, or specific applications) from running while certain safety critical features are performed. In step 1202, the UDPD may prevent additional applications from running (e.g., running in the background), prior to performing safety critical features. In step 1204, the UDPD may perform safety critical features(s) of the SCA (e.g., such as step 502, 504, 506, 508, or a combination thereof as shown in FIG. 5). After the safety critical features are performed (i.e., run, completed), the UDPD may enable the additional applications to run, as recited in step 1206.

FIG. 13 provides a flow diagram depicting disabling incoming calls while running safety critical feature(s) of application, according to some aspects of the subject methods. In certain aspects, depending on permissions given to the SCA, the UDPD may disable the capability to receive communications via a network (e.g., a WiFi or cellular network), such as disabling the capability to receive incoming calls or messages (e.g., text messages, SMS messages, MMS messages, and/or the like) and/or send outgoing messages or make outgoing calls prior to performing the safety critical features, as recited in step 1302. For example, the SCA may instruct the UDPD to activate an “airplane mode” and/or prevent an “answer screen” from being displayed prior to running the safety critical features. In step 1304, the UDPD may perform safety critical features(s) of the SCA (e.g., such as step 502, 504, 506, 508, or a combination thereof as shown in FIG. 5). After the safety critical features are performed (e.g., run, completed), the UDPD may enable the capability to receive and send network communications (e.g., receive or send messages and/or calls), as recited in step 1306.

Restarting Safety Critical Features after Interruption—

Safety critical features may include discrete tasks with completion endpoints. For example, a scan (e.g., of an on-body unit by the UDPD) is an operation that has a well-defined end point. If the operation is preempted before reaching the end point, then the intermediate results of the operation may be discarded. A high level sequence is: a) User initiates a Scan Operation; b) Perform an NFC read using the NFC API; c) Log the raw packet, (optional—engineering configuration); d) Process the packet into BG (the algorithm calculation), with real time and historic values; e) Filter to remove values previously logged; f) Add new values to the Log; g) Display Real Time Result. Steps a) through f) may need to be completed without preemption or interruption. After preemption or interruption, when the SCA is “started” again, the SCA will abandon the partial scan. The user Interface may automatically initiate a new scan, or require the user to initiate a new scan.

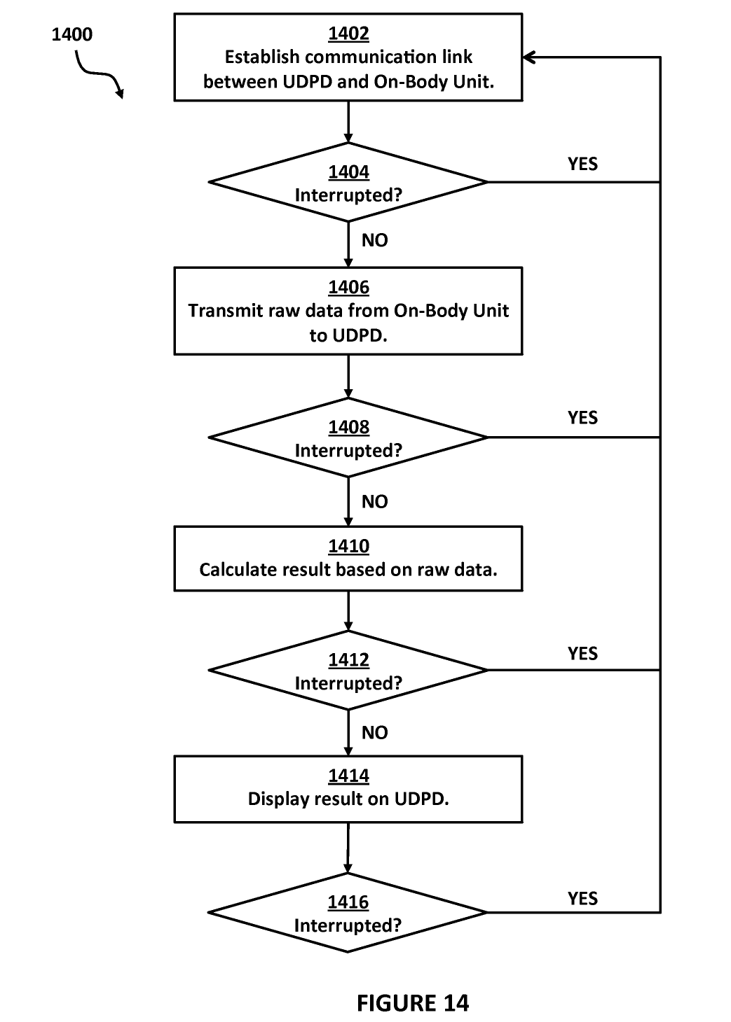

FIG. 14 provides a flow diagram depicting termination of interrupted safety critical feature(s) and restarting interrupted safety critical feature(s), according to some aspects of the subject methods. A safety critical feature may be interrupted by another application (e.g., running in the background), a phone function (such as an incoming call), and so forth. An interruption may be detected when a safety critical feature takes more than a predetermined amount of time to be completed. An interruption may be inferred when a calculation gives an unexpected result (e.g., as determined according to the steps shown in FIG. 6 or 7). Additionally or alternatively, an interruption may be detected when a safety critical feature is terminated prior to completion. As shown in FIG. 14, when safety critical applications of step 1402, 1406, 1410, 1414, or a combination thereof, are determined to be interrupted, the safety critical applications may be repeated. After interruption, the entirety of the safety critical features may be repeated (e.g., as shown in FIG. 14). Alternatively, only the most recent step (e.g., the step which was interrupted) may be repeated.

In certain aspects, the user may be prompted to approve repeating the safety critical feature(s). An interruption of a safety critical feature may trigger one or more diagnostic steps, such as those described in FIG. 6, 7, 8 or 9. Alternatively or in addition, an interruption of a safety critical feature may trigger the UDPD to prevent additional application(s) from running (e.g., as shown in FIG. 12) and/or disable the capability to receive incoming calls (e.g., as shown in FIG. 13).

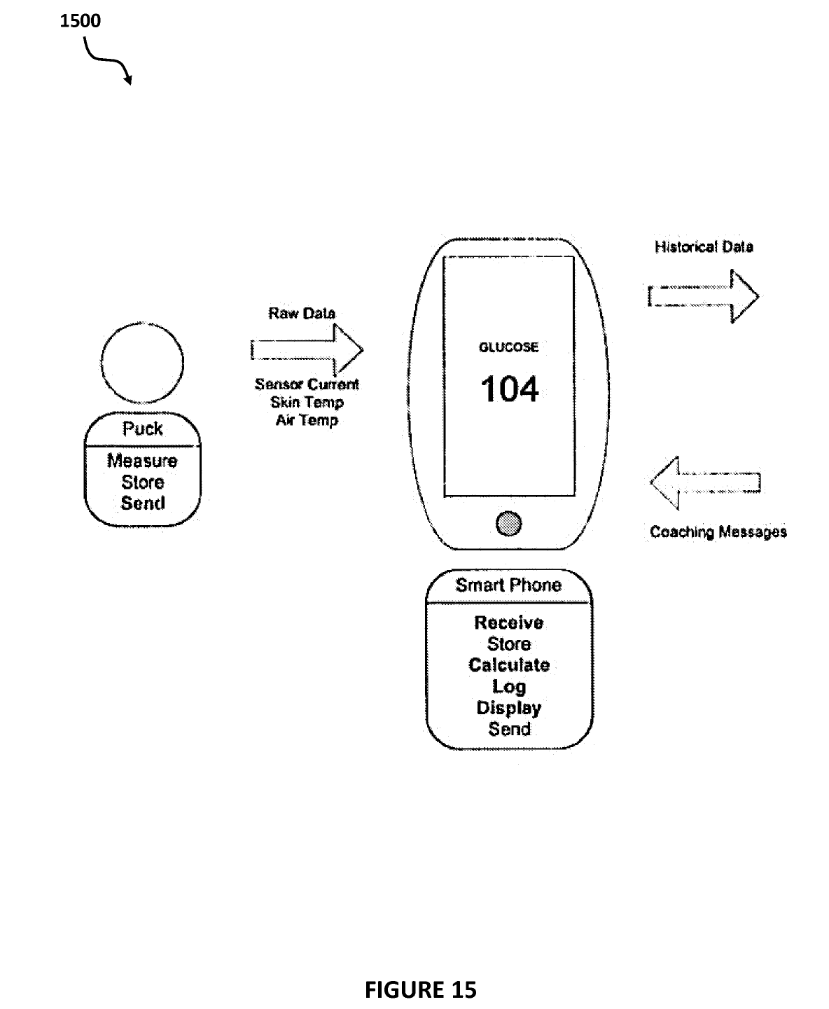

FIG. 15 provides a flow diagram depicting safety critical features, according to some aspects of the subject methods. In certain aspects, the safety critical system may be a system to detect blood glucose levels in a subject (e.g., the user of the UDPD). As such, the communication device is referred to in this figure as a “puck” (depicted for illustration purposes as a round circle). The puck is capable of taking measurements from a sensor. The measurements may be of the sensor current (e.g., current due to the oxidation of glucose), skin temperature, air temperature, and so forth. The puck may store measurements prior to sending them (i.e., as raw data) to the smart phone. The smart phone may be configured to receive the raw data, store the raw data, calculate a result (e.g., glucose level) based on the raw data, log (or store) the result or a history of results, and display the result or a history of results to the user. The smart phone may further be configured to send the results (e.g., historical result data) to an external server or servers (such as servers), which may provide further computation and may return, for example, coaching messages to be displayed to the user.

The user may activate the SCA on their phone and “read” the puck with the NFC feature of the phone. The SCA may enable the phone to interface to the puck. Each phone model may have an internal NFC antenna that can be placed over the puck to get a link. The user may have to learn where the “sweet spot” of the internal antenna is to get a link to the puck. The SCA may confirm the “read” with a progress tone for the user so they will know when the link was successful. Since this is an “open platform”, the integrity of the data “read” from the puck may be established.

As shown in FIG. 15, the puck may send raw data to the smart phone. When the phone is in range and aligned to the puck, the SCA may create an NFC link from the puck to the phone. This is a short range wireless communication (e.g., using the IS015693 protocol) with the raw sensor current (e.g., corresponding to glucose oxidation) and temperature data transmitted in a data packet that includes recent data (e.g., within previous minute) and stored historical values. A CRC for the packet contents may ensure the complete packet is received.

The smart phone may then calculate a result (e.g., glucose value) based on the raw data. The phone may convert the raw data to a glucose value with the algorithm. Since this is an “open platform” the integrity of the calculation must be established. The result would then be stored in the glucose value log. The new data would be appended to the existing log and overlapping data may be compared and filtered out.

The smart phone may then display the calculated glucose result, trends, and graphs of the historical data from the glucose value log. Since this is an “open platform” the integrity of the result displayed may be established.

Throughout the foregoing description, for the purposes of explanation, numerous specific details were set forth in order to provide a thorough understanding of the present disclosure. It will be apparent, however, to one skilled in the art that the methods of the present disclosure may be practiced without some of these specific details. In addition, embodiments of the invention may include various operations as set forth above, or fewer operations or more operations, or operations in an order which is different from the order described herein. Accordingly, the scope and spirit of the methods of the present disclosure should be judged in terms of the claims which follow as well as the legal equivalents thereof.

It should be understood that techniques introduced in the preceding can be implemented by programmable circuitry programmed or configured by software and/or firmware, or they can be implemented entirely by special-purpose “hardwired” circuitry, or in a combination of such forms. Such special-purpose circuitry (if any) can be in the form of, for example, one or more application-specific integrated circuits (ASICS), programmable logic devices (PLDs), field-programmable gate arrays (FPGAs), etc.

Software or firmware implementing the techniques introduced herein may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing took, any device with one or more processors, etc.). For example, a machine-readable medium can be used to store software instructions, which when executed by a processor, causes the processor to perform the various methods of this description. A machine-readable medium includes recordable/non-recordable media (e.g., read-only memory (ROM); random access memory (RAM); magnetic disk storage media; optical storage media; flash memory devices; etc.), or any type of media suitable for storing machine-readable instructions. The term “logic”, as used herein, can include, for example, special purpose hardwired circuitry, software and/or firmware in conjunction with programmable circuitry, or a combination thereof.

The preceding merely illustrates the principles of the present disclosure. It will be appreciated that those skilled in the art will be able to devise various arrangements which, although not explicitly described or shown herein, embody the principles of the present disclosure and are included within its spirit and scope. Furthermore, all examples and conditional language recited herein are principally intended to aid the reader in understanding the principles of the present disclosure and the concepts contributed by the inventors to furthering the art, and are to be construed as being without limitation to such specifically recited examples and conditions. Moreover, all statements herein reciting principles, aspects, and aspects of the present disclosure as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary aspects shown and described herein. Rather, the scope and spirit of present disclosure is embodied by the appended claims.

While the above embodiments may be applied to detecting glucose levels, the above embodiments could conceivably be applied to any system or methods for detecting levels of a biomarker in a subject or taking other measurements (such as heart rate, blood pressure, body temperature, and so forth). In any of the above described methods, the user of the UDPD may be prompted to proceed with certain steps. For example, prior to updating the SCA to be compatible with the UDPD operating system, as recited in step 810 of FIG. 8, the method may include prompting the user to proceed with the update. In any of the above described methods, steps performed by the UDPD may be based on executable instructions provided by the SCA.

What is claimed is:

1. A method for hosting a safety critical application on an uncontrolled data processing device, the method comprising:
transmitting reference data from an on-body unit (OBU) to an uncontrolled data processing device (UDPD), wherein the UDPD comprises a processor, a non-transitory computer readable medium, and a safety critical application (SCA) installed on the non-transitory computer readable medium that causes the processor to:
calculate a value based on the reference data; and
compare the calculated value with a reference value;
preventing the SCA from operating freely when the calculated value is different from the reference value; and
permitting the SCA to operate freely when the calculated value matches the reference value.

2. The method according to claim 1, further comprising obtaining the reference data from an analog signal, prior to the step of transmitting.

3. The method according to claim 1, wherein the OBU does not comprise a sensor inserted into the body of a user.

4. The method according to claim 1, wherein the reference data is a digital reference data stored on a non-transitory computer readable medium of the OBU.

5. The method according to claim 4, wherein a sensor of the OBU is inserted into the body of a user prior to transmitting the digital reference signal from the OBU to the UDPD.

6. The method according to claim 5, wherein the digital reference signal comprises data pre-loaded on the OBU during manufacture of the OBU.

7. The method according to claim 6, wherein permitting the SCA to operate freely comprises overwriting the pre-loaded data corresponding to the reference signal with data corresponding to signal generated from a sensor of the OBU.

8. The method according to claim 4, wherein the OBU is a control OBU that does not comprise a sensor.

9. The method according to claim 4, wherein the digital reference signal is derived from an identification code associated with the OBU.

10. The method according to claim 1, wherein preventing the SCA from operating freely comprises disabling safety critical features of the SCA.

11. The method according to claim 10, wherein preventing the SCA from operating freely further comprises enabling non-safety critical features of the SCA.

12. The method according to claim 1, further comprising placing the UDPD in a reference signal calculation mode, prior to transmission of the reference signal from the OBU to the UDPD.

13. A method for hosting a safety critical application on an uncontrolled data processing device, the method comprising:
transmitting data from an on-body unit (OBU) to an uncontrolled data processing device (UDPD);
calculating, using the UDPD, a value based on the transmitted data;
comparing, using the UDPD, the calculated value to a range of possible physiologic values;
preventing, using the UDPD, a safety critical application (SCA) installed on the UDPD from operating freely when the data falls outside the range of possible physiologic values; and
permitting, using the UDPD, the SCA to operate freely when the data falls within the range of possible physiologic values.

14. The method according to claim 13, wherein the range of possible physiologic values is based on historic values previously calculated using signals from a sensor of the OBU.

15. The method according to claim 14, wherein the range of possible physiologic values is predetermined and independent of historic values previously calculated using signals from a sensor of the OBU.

16. The method according to claim 13, wherein preventing the SCA from operating freely comprises disabling safety critical features of the SCA.

17. The method according to claim 13, wherein preventing the SCA from operating freely further comprises enabling non-safety critical features of the SCA.

18. A method for hosting a safety critical application on an uncontrolled data processing device, the method comprising:
determining whether an operating system or version thereof of an uncontrolled data processing device (UDPD) is an operating system approved for use with a safety critical application (SCA);
preventing, using the UDPD, the SCA from operating freely when the operating system or version thereof is not approved for use with the SCA; and
permitting, using the UDPD, the SCA to operate freely when the operating system or version thereof is approved for use with the SCA.
